(19) United States
(12) Patent Application Publication
(10) Pub. No.: US 2014/0202645 A1
(43) Pub. Date: Jul. 24, 2014

(54) Sunshade Assembly

(71) Applicant: Macauto Industrial Co., Ltd., Tainan City (TW)

(72) Inventors: Paul Lin, Tainan City (TW); Huei-Ho Wang, Tainan City (TW)

(73) Assignee: Macauto Industrial Co., Ltd., Tainan City (TW)

(21) Appl. No.: 14/155,641

(22) Filed: Jan. 15, 2014

(30) Foreign Application Priority Data
Jan. 18, 2013 (TW) 102102010

(51) Int. Cl. B60J 1/20

(52) U.S. Cl. CPC B60J 1/2091
USPC 160/370.21

(57) ABSTRACT

A sunshade assembly includes two support rollers adapted to roll on a window panel of a vehicle when a pull rod is moved relative to a base seat for placing a screen between extended and wound up positions. A cover plate is disposed above the pull rod. Two slide members are respectively connected to the cover plate to enable the cover plate to move between a first position in which the support rollers extend beyond the cover plate, and a second position in which the support rollers do not extend beyond the cover plat. When the pull rod is moved toward the base seat, and when the slide members are pushed by two tracks, the cover plate is moved to the second position from the first position.

### CROSS-REFERENCE TO RELATED APPLICATION

This application claims priority to Taiwanese Application No. 102102010, filed on Jan. 18, 2013.

### BACKGROUND OF THE INVENTION

1. Field of the Invention

The invention relates to a sunshade assembly, and more particularly to a sunshade assembly that is adapted to be installed in a housing disposed in proximity to a window panel of a vehicle.

2. Description of the Related Art

A conventional sunshade assembly is installed in a base that is formed with a groove and that is disposed in proximity to a window panel of a vehicle. The conventional sunshade assembly includes a sunshade unit including a hollow seat that is mounted in a bottom portion of the base, a screen that is extendably wound up in the hollow seat, and a pull rod that is mounted to a distal end of the screen and that is disposed outward of the base. When in use, the pull rod is driven by an expansion-driving member of the conventional sunshade assembly to move relative to the hollow seat and away from the groove of the base for drawing the screen out of the hollow seat through the groove and placing the screen in an extended state, or to move toward the groove of the base for allowing the screen to wind up in the hollow seat and be placed in a wound up state.

In order to prevent dust or contaminants from falling into the groove of the base, the conventional sunshade assembly can further include a cover plate that is disposed on the pull rod. When the screen is completely wound up, the pull rod is situated in proximity to the groove of the base and the cover plate covers the groove. However, since the pull rod is only supported by the expansion-driving member, movement of the pull rod away from the base is unstable. In addition, during movement of the vehicle, the pull rod tends to collide with the window panel, making noise and even damaging the window panel.

In order to prevent collision of the pull rod with the window panel, an improved sunshade assembly disclosed in U.S. Pat. No. 6,422,291 B1, which has a structure similar to that of the abovementioned conventional sunshade assembly, further includes two guide units that are respectively disposed at two opposite ends of the pull rod and connected with the cover plate and the pull rod. Each of the guide units has a roller that is rollable on the window panel and a resilient member that abuts against the roller. When the cover plate covers the groove of the base, the roller of each of the guide units is covered by the cover plate and is received in the base seat, and thus the resilient member of the respective guide unit can store a restoring force due to pressing of the roller. When the pull rod moves away from the base, along moving the roller of each of the guide units away from the base, by releasing the restoring forces, the resilient members of the guide units respectively push the rollers of the guide units outward of the cover plate and to be in contact with the window panel, such that the rollers of the guide units roll on the window panel and prevent collision of the pull rod with the window panel.

### SUMMARY OF THE INVENTION

Therefore, an object of the present invention is to provide a sunshade assembly with a novel structure that is adapted to be installed in a housing disposed in proximity to a window panel of a vehicle and that is movable relative to the housing for covering the window panel of the vehicle in a much smoother manner.

According to the present invention, a sunshade assembly includes a sunshade unit, a pair of guide units, a cover unit and a pair of tracks.

The sunshade unit includes a base seat that is adapted to be mounted in the housing, a screen that is extendably wound up in the base seat, a pull rod that is mounted on an end of the screen opposite to the base seat and that is adapted to be disposed above the housing. The pull rod is operable to move upward and away from the base seat for placing the screen in an extended position, or to move downwards toward the base seat for placing the screen in a wound up position.

The guide units are respectively connected to two opposite sides of the pull rod. Each of the guide units includes a mount that is coupled to the pull rod, and a support roller that is mounted on the mount. The support rollers of the guide units are adapted to roll on the window panel when the pull rod is moved toward or away from the base seat.

The cover unit includes a cover plate that extends along a lengthwise direction of the pull rod and that is disposed above the pull rod and the guide units, and a pair of slide members that are respectively connected to two end portions of the cover plate and that are respectively and telescopically mounted in the mounts of the guide units to enable the cover plate to move transversely of the pull rod between a first position in which the support rollers extend beyond the cover plate, and a second position in which the support rollers do not extend beyond the cover plate.

The tracks are adapted to be mounted in the housing. As the pull rod is moved toward the base seat, when the slide members respectively come into contact with the tracks, the slide members are respectively pushed by the tracks to move relative to the mounts, such that the cover plate is moved to the second position from the first position.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a sunshade assembly according to the present invention in an extended state;

FIG. 2 is an enlarged fragmentary perspective view illustrating cooperation among a cover unit, a guide unit and a sunshade unit of the preferred embodiment;

FIG. 3 is an exploded fragmentary perspective view illustrating the structure of the guide unit and the cover unit of the preferred embodiment;

FIG. 4 is a fragmentary side sectional view illustrating the preferred embodiment in the extended state;

FIG. 5 is a fragmentary side sectional view illustrating the preferred embodiment in a retracted state.

### DETAILED DESCRIPTION OF THE PREFERRED EMBODIMENT

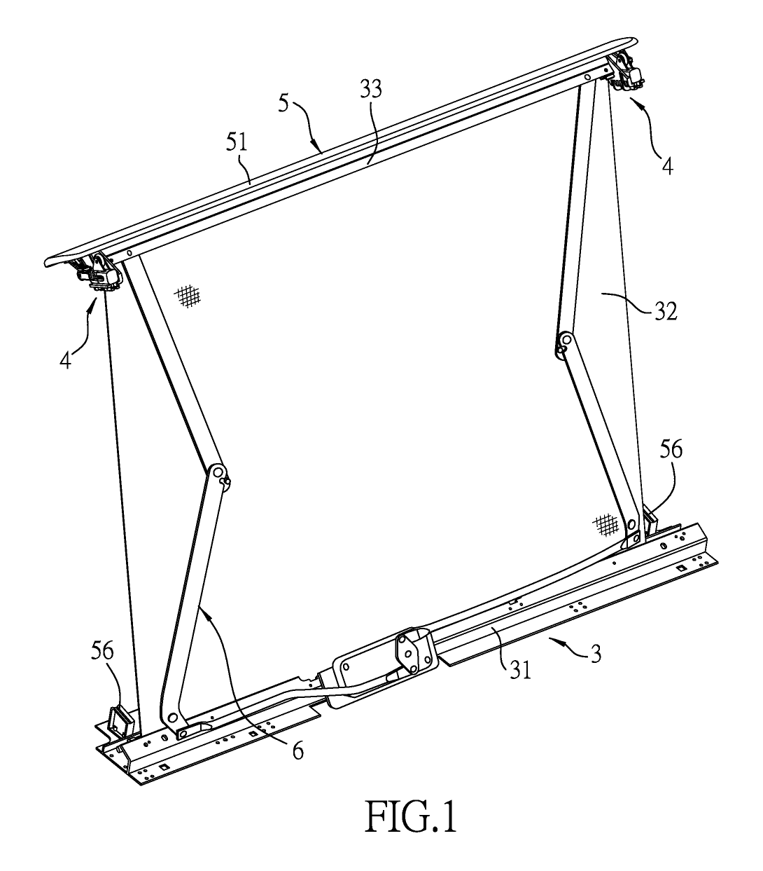

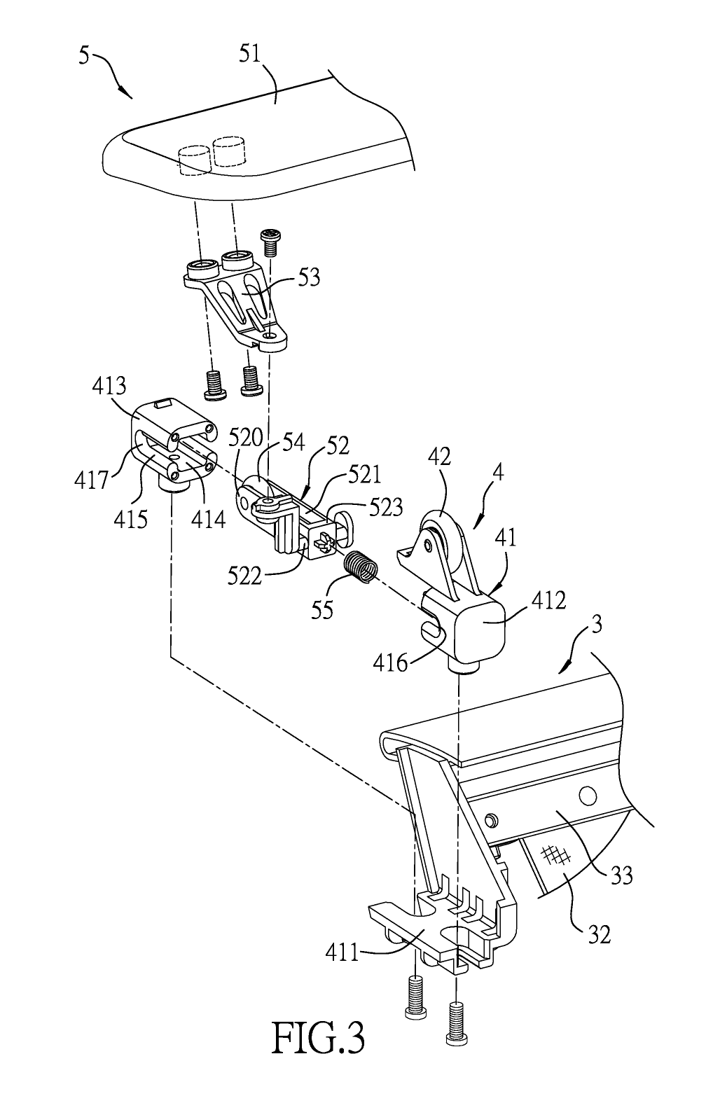

FIGS. 1 to 5 illustrate the preferred embodiment of a sunshade assembly according to the present invention. The sunshade assembly is adapted to be installed in a housing 1 that is disposed in proximity to a window panel 2 of a vehicle (not shown). In this embodiment, the window panel 2 is a vehicular rear window. However, the present invention is not limited in this respect and the window panel 2 adapted to be mounted with the sunshade assembly of this invention may as well be one of vehicular side windows.

In this preferred embodiment, the sunshade assembly includes a sunshade unit 3, a pair of guide units 4, a cover unit 5 and a pair of tracks 56. Preferably, the sunshade assembly further includes an actuating unit 6 that is extendably connected to the sunshade unit 3, the guide units 4 and the cover unit 5. Since the feature of this invention does not reside in the actuating unit 6, which may be readily appreciated by those skilled in the art, details of the same are omitted herein for the sake of the brevity.

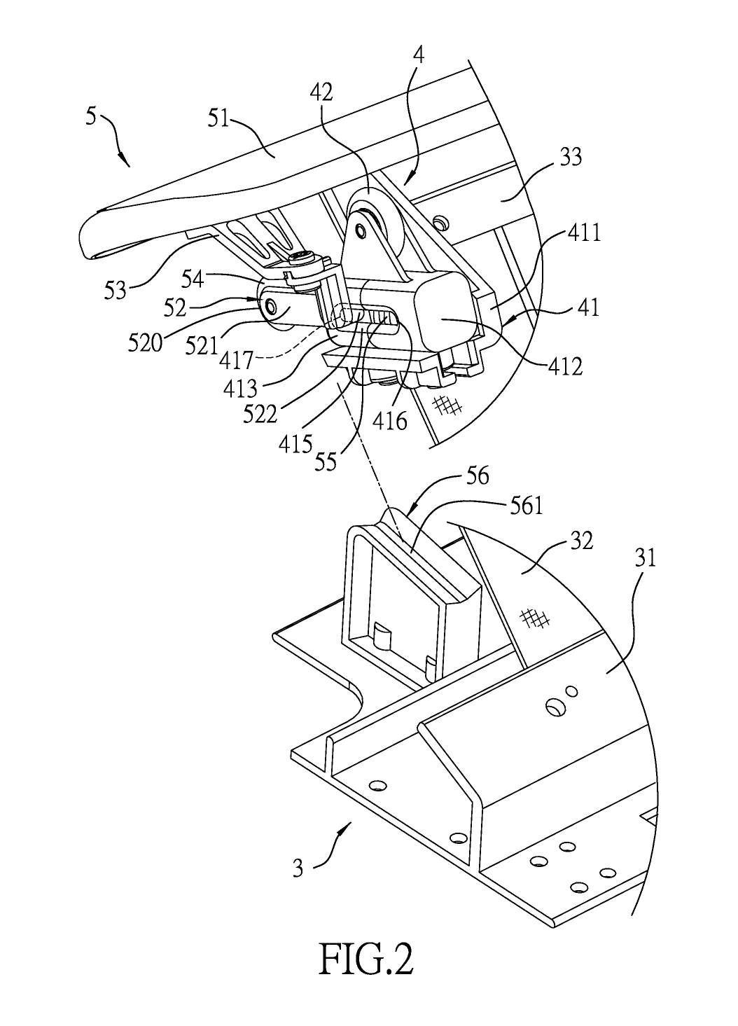

With reference to FIGS. 2 to 5, the sunshade unit 3 includes a base seat 31 that is adapted to be mounted in the housing 1, a screen 32 that is extendably wound up in the base seat 31, and a pull rod 33 that is mounted on an end of the screen 32 opposite to the base seat 31 and that is adapted to be disposed above the housing 1. The pull rod 33 is operable to move upward and away from the base seat 31 for placing the screen 32 in an extended position, or to move downwards toward the base seat 31 for placing the screen 32 in a wound up position. Preferably, the sunshade unit 3 can further include a winding shaft (not shown) that is rotatably mounted in the base seat 31 and a torsion spring (not shown) that is connected to the winding shaft and that enables the winding shaft to rotate back to its original position. Accordingly, the screen 32 is extendably wound around the winding shaft. Since the feature of this invention does not reside in the winding shaft and the torsion spring, which may be readily appreciated by those skilled in the art, details of the same are omitted herein for the sake of the brevity.

The guide units 4 are respectively connected to two opposite ends of the pull rod 33. Each of the guide units 4 includes a mount 41 that is coupled to the pull rod 33, and a support roller 42 that is mounted on the mount 41. The support rollers 42 of the guide units 4 are adapted to roll on the window panel 2 when the pull rod 33 is moved toward or away from the base seat 31. Preferably, each of the guide units 4 further includes a connection plate 411 that is connected to the pull rod 33 and the mount 41.

In this preferred embodiment, the mount 41 of each of the guide units 4 has a slide slot 414 that extends transversely of the pull rod 33. Preferably, the mount 41 of each of the guide units 4 further has an elongate lateral opening 415 that extends parallel to the slide slot 414 and that is communicated with the slide slot 414. More preferably, the mount 41 of each of the guide units 4 further has a first casing part 412 that is coupled to the connection plate 411 and that holds the support roller 42 in a rotatable manner, and a second casing part 413 that is coupled to the connection plate 411 and the first casing part 412. The first and second casing parts 412, 413 cooperatively define the slide slot 414 that extends from the first casing part 412 to the second casing part 413. In addition, the first and second casing parts 412, 413 of the mount 41 of each of the guide units 4 further cooperatively define the lateral opening 415. In this preferred embodiment, the lateral opening 415 has a first abutment portion 416 that is situated on the first casing part 412, and a second abutment portion 417 that is situated on the second casing part 413. Alternatively, for each of the guide units 4, the connection plate 411 can be omitted. In such a way, the first and second casing parts 412, 413 of the mount 41 of each of the guide units 4 are directly mounted to the pull rod 33. However, the configurations of the first and second casing parts 412, 413 of the mount 41 of each of the guide units 4 are variable without being limited in this respect.

The cover unit 5 includes a cover plate 51 that extends along a lengthwise direction of the pull rod 33 and that is disposed above the pull rod 33 and the guide units 4, and a pair of slide members 52 (only one is shown in FIGS. 2 to 5) that are respectively connected to two end portions of the cover plate 51 and that are respectively and telescopically mounted in the mounts 41 of the guide units 4 to enable the cover plate 51 to move transversely of the pull rod 33 between a first position in which the support rollers 42 extend beyond the cover plate 51, and a second position in which the support rollers 42 do not extend beyond the cover plat 51. In this preferred embodiment, the cover unit 5 further includes a pair of resilient members 55 that are respectively mounted in the mounts 41 of the guide units 4 and that respectively urge the slide members 52 to move outwardly of the mounts 41 of the guide units 4. Preferably, each of the resilient members 55 is a compression spring that is mounted in the first casing part 412 of the mount 41 of the respective one of the guide units 4.

In this preferred embodiment, the slide slot 414 of each of the guide units 4 is used to receive a respective one of the slide members 52 and a respective one of the resilient members 55. Each of the slide members 52 has an end portion 520 that extends out of the mount 41 of the respective guide unit 4, and a guide roller 54 that is attached to the end portion 520. In this preferred embodiment, the end portion 520 of each of the slide members 52 is disposed outside the slide slot 414. Another end portion 523 of each of the slide members 52 is connected to the respective one of the resilient members 55. Preferably, each of the slide member 52 further has an extension portion 522 that projects outward through the lateral opening 415 of a respective one of the mounts 41 from the another end portion 523 so as to be connected to the cover plate 51 and that is movable along the lateral opening 415 between the first and second abutment portions 416, 417. In such a way, each of the slide members 52 is able to telescopically and partially extend out of the mount 41 of the respective one of the guide units 4. Preferably, the cover unit 5 further includes a pair of linking arms 53 (only one is shown in FIGS. 2 to 5). Each of the linking arms 53 interconnects the extension portion 522 of a respective one of the slide members 52 and the cover plate 51. However, the present invention is not limited in this respect. The linking arms 53 can be omitted as long as the extension portions 522 of the slide members 52 are connected to the cover plate 51.

In this preferred embodiment, the tracks 56 are adapted to be mounted in the housing 1. As the pull rod 33 is moved toward the base seat 31, when the slide members 52 respectively come into contact with the tracks 56, the slide members 52 are respectively pushed by the tracks 56 to move relative to the mounts 41 such that the cover plate 51 is moved to the second position from the first position. In this preferred embodiment, the slide members 52 are respectively pressed by the tracks 56 against the resilient members 55 to respectively retract inward of the mounts 41 when in contact with the tracks 56, respectively. Since, for each of the slide members 52, the guide roller 54 is attached to the end portion 520, the guide roller 54 can contact and roll on the respective one of the tracks 56 when the pull rod 33 is moved toward and close to the base seat 31. Preferably, each of the tracks 56 has a leading surface 561 to guide the guide roller 54 of the respective one of the slide members 52, such that the guide roller 54 of the respective one of the slide members 52 is able to roll on and be pressed by the leading surface 561.

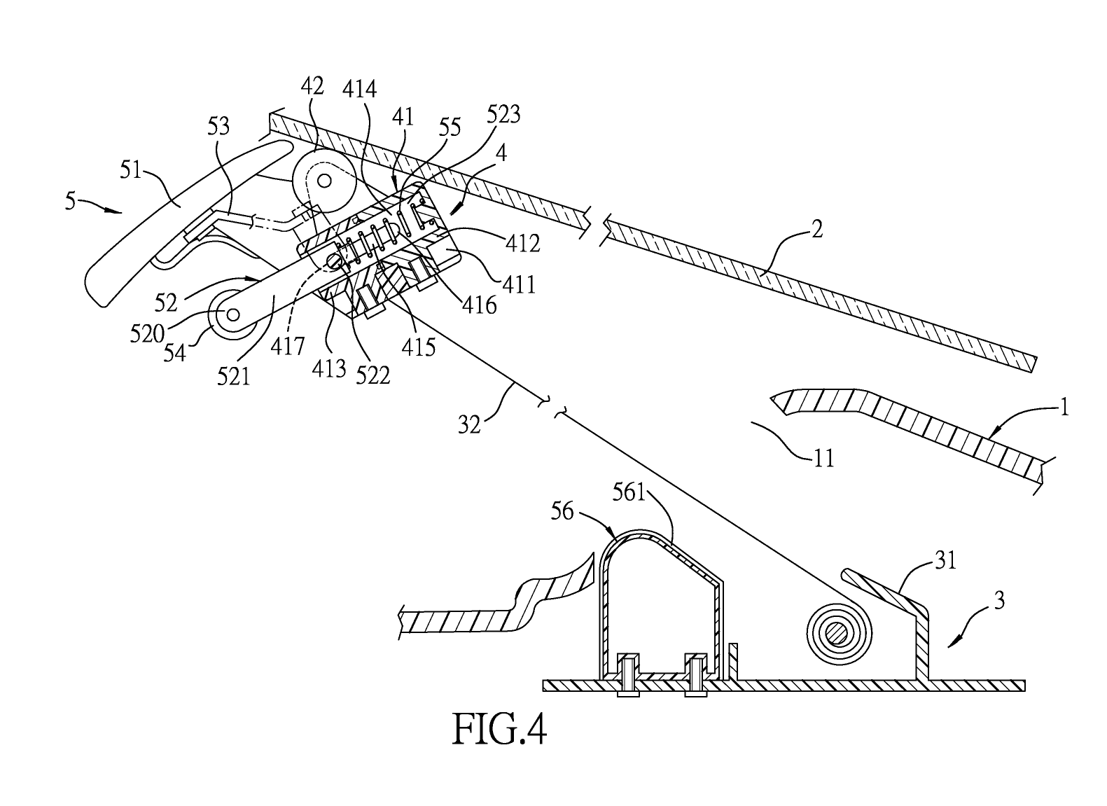

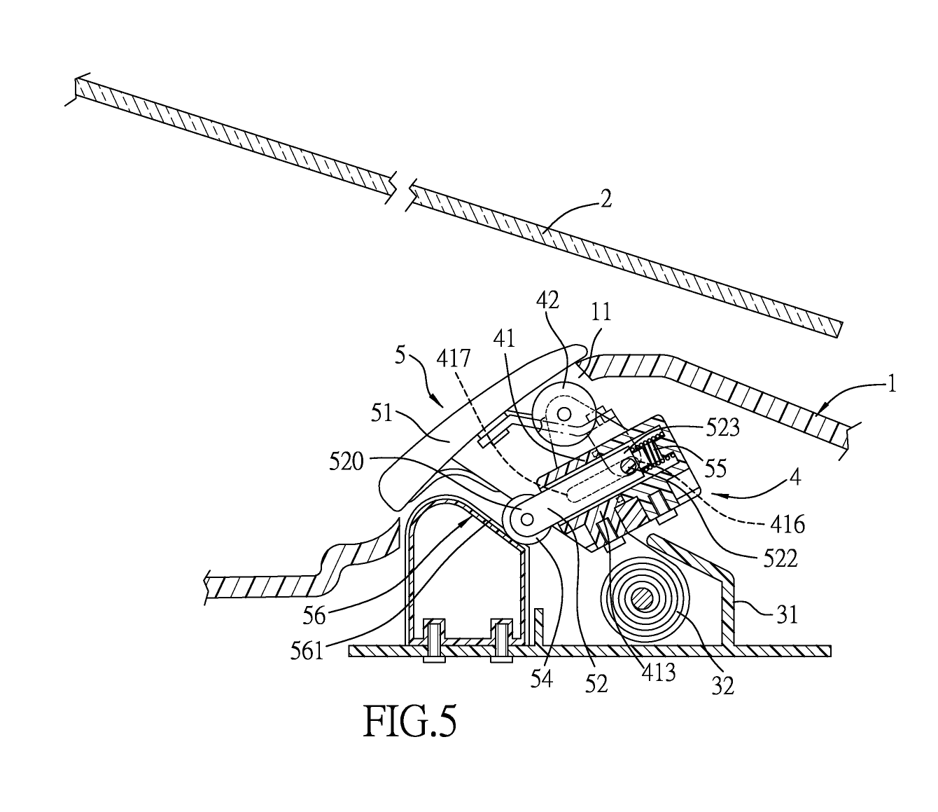

With reference to FIGS. 4 and 5, when the pull rod 33 (see FIG. 2) is driven to move upward and away from the base seat 31, the cover unit 5 and the guide units 4 (only one is visible) are driven to move away from the base seat 31. Accordingly, when the guide rollers 54 (only one is visible) of the slide members 52 (only one is visible) are not pressed by the tracks 56 (only one is visible), the resilient members 55 (only one is visible) respectively urge the slide members 52 to move toward the second casing parts 413 (only one is visible) of the mounts 41 (only one is visible) of the guide units 4. The extension portion 522 of each of the slide members 52 moves from the first abutment portion 416 to the second abutment portion 417 of the mount 41 of the respective one of the guide units 4. As the cover plate 51 moves to the first position relative the pull rod 33, the support rollers 42 respectively extend beyond the cover plate 51. When the support rollers 42 respectively roll on the window panel 2, the support rollers 42 prevent collision between the pull rod 33 and the window panel 2 so as to enable the pull rod 33 to have stable movement relative to the window panel 2.

When the pull rod 33 is driven to move with the cover plate 51 downwards toward the base seat 31, the support rollers 42 move together with the pull rod 33 and roll on the window panel 2 toward the base seat 31. As the guide rollers 54 of the slide members 52 respectively come into contact with the leading surfaces 561 of the tracks 56 and are respectively pressed by the tracks 56, the cover plate 51 moves in the second position. By virtue of the tracks 56 respectively pressing the guide rollers 54 of the slide members 52, the slide members 52 are respectively retracted inward of the mounts 41, and thus respectively press the resilient members 55. In such a manner, the extension portion 522 of each of the slide members 52 moves from the second abutment portion 417 to the first abutment portion 416. As a result, the cover plate 51 moves to the second position such that the support rollers 42 move to the housing 1 and the housing 1 is covered by the cover plate 51, thereby preventing dust and contaminants from entering the housing 1.

To sum up, during movement of the pull rod 33, the guide units 4 enable the pull rod 33 to stably move without colliding with the window panel 2. When the pull rod 33 is driven to move downwards toward the base seat 31 and becomes close to the base seat 31, by virtue of the tracks 56 respectively pressing the guide rollers 54 of the slide members 52, the slide members 52 are retracted inward of the mounts 41, resulting in transverse movement of the cover plate 51 to the pull rod 33. Once the cover plate 51 completely covers the support rollers 42 of the mounts 41 and the housing 1, the screen 32 is wound up in the base seat 31 and the cover plate 51 prevents dust and contaminants from entering the housing 1. Hence, due to the structure of the sunshade assembly according to the present invention, the tracks 56 are capable of guiding the cover unit 5 to enable the guide units 4 to move into/out of the housing 1 in a smoother manner, such that the screen 32 of the sunshade assembly can be movable relative to the housing 1 for covering/uncovering the window panel 2 much more smoothly.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A sunshade assembly adapted to be installed in a housing that is disposed in proximity to a window panel of a vehicle, said sunshade assembly comprising:
a sunshade unit including a base seat that is adapted to be mounted in the housing, a screen that is extendably wound up in said base seat, and a pull rod that is mounted on an end of said screen opposite to said base seat and that is adapted to be disposed above the housing, said pull rod being operable to move upward and away from said base seat for placing said screen in an extended position, or to move downward and toward said base seat for placing said screen in a wound up position;
a pair of guide units respectively connected to two opposite sides of said pull rod, each of said guide units including a mount that is coupled to said pull rod, and a support roller that is mounted on said mount, said support rollers of said guide units being adapted to roll on the window panel when said pull rod is moved toward or away from said base seat;
a cover unit including a cover plate that extends along a lengthwise direction of said pull rod and that is disposed above said pull rod and said guide units, and a pair of slide members that are respectively connected to two end portions of said cover plate and that are respectively and telescopically mounted in said mounts of said guide units to enable said cover plate to move transversely of said pull rod between a first position in which said support rollers extend beyond said cover plate, and a second position in which said support rollers do not extend beyond said cover plat; and
a pair of tracks that are adapted to be mounted in the housing;
wherein, as said pull rod is moved toward said base seat, when said slide members respectively come into contact with said tracks, said slide members are respectively pushed by said tracks to move relative to said mounts such that said cover plate is moved to the second position from the first position.

2. The sunshade assembly as claimed in claim 1, wherein said cover unit further includes a pair of resilient members that are respectively mounted in said mounts of said guide units, and that respectively urge said slide members to move outwardly of said mounts of said guide units, said slide members being respectively pressed by said tracks against said resilient members to respectively retract inward of said mounts when in contact with said tracks.

3. The sunshade assembly as claimed in claim 2, wherein each of said slide members has an end portion that extends out of the respective one of said mounts, and a guide roller that is attached to said end portion to contact and roll on the respective one of said tracks when said pull rod is moved toward said base seat.

4. The sunshade assembly as claimed in claim 3, wherein said mount of each of said guide units has a slide slot that extends transversely of said pull rod to receive the respective one of said slide members and the respective one of said resilient members, said end portion of each of said slide members being disposed outside of said slide slot of said mount of the respective one of said guide units, another end portion of each of said slide members being connected to the respective one of said resilient members.

5. The sunshade assembly as claimed in claim 4, wherein said mount of each of said guide units further has an elongate lateral opening that extends parallel to said slide slot and that is communicated with said slide slot, each of said slide members further having an extension portion that projects outward through said lateral opening from said another end portion so as to be connected to said cover plate and that is movable along said lateral opening.

6. The sunshade assembly as claimed in claim 5, wherein each of said guide units further includes a connection plate that is connected to said pull rod and said mount.

7. The sunshade assembly as claimed in claim 6, wherein said mount of each of said guide units further has a first casing part that is coupled to said connection plate and that holds said support roller in a rotatable manner, and a second casing part that is coupled to said connection plate and said first casing part, said first and second casing parts cooperatively defining said slide slot that extends from said first casing part to said second casing part.

8. The sunshade assembly as claimed in claim 7, wherein said first and second casing parts of said mount of each of said guide units further cooperatively define said lateral opening, said lateral opening having a first abutment portion that is situated on said first casing part and a second abutment portion that is situated on said second casing part, said extension portion of each of said slide members being movable in said lateral opening of the respective one of said mounts between said first and second abutment portions.

9. The sunshade assembly as claimed in claim 5, wherein said cover unit further includes a pair of linking arms, each of said linking arms interconnecting said extension portion of a respective one of said slide members and said cover plate.
